(19) United States
(12) Patent Application Publication
(10) Pub. No.: US 2014/0085048 A1
(43) Pub. Date: Mar. 27, 2014

(54) System and Method for Unlocking an Electronic Device Via a Securely Paired Remote Device

(71) Applicant: MOTOROLA MOBILITY LLC, Libertyville, IL (US)

(72) Inventor: Peyman Hadizad, Redwood City, CA (US)

(73) Assignee: Motorola Mobility LLC, Libertyville, IL (US)

(21) Appl. No.: 13/626,311

(22) Filed: Sep. 25, 2012

(51) Int. Cl. G05B 19/00

(52) U.S. Cl. 340/5.64

(57) ABSTRACT

An electronic device and a method for unlocking the electronic device is disclosed herewith. The method includes pairing the electronic device with a remote device. The electronic device authenticates the remote device and thus establishes a secure and trusted connection. Furthermore, the method includes generating a password, at the electronic device, in response to the occurrence of an event. The generated password is then transmitted acoustically to the remote device. A user, after hearing the password, thereafter provides, within a predetermined time, at least one input at the electronic device, wherein the at least one input corresponds to the password. In other words, the electronic device receives at least one password within the predetermined time. The method further includes unlocking the electronic device in response to determining that the at least one input matches the password.

### FIELD OF THE DISCLOSURE

The present disclosure generally relates to wireless and wired communication and more particularly to unlocking of an electronic device via a securely paired remote device.

### BACKGROUND

Authentication is an act of confirming the truth of an attribute of a datum or entity. User authentication is a central component of currently employed wireless and wired communication systems. User authentication means determining whether a person attempting to access a system is authorized for such access. In general, user authentication methods fall into three broadly defined categories, with the said categories being related to either certain information that the user has knowledge of, such as a password, or certain information which the user has possession of, such as a token, or one or more physical characteristics of the user, such as the user's facial or fingerprint profile.

Password authentication is perhaps the simplest authentication model to implement, and as a result password authentication methods are quite common. Unfortunately, password authentication is also a weak form of authentication because passwords can be guessed or stolen relatively easily. Passwords can also become known to hackers over time. Furthermore, passwords have to be remembered, and there is also a possibility that a user of the electronic device might forget a difficult password.

To overcome some of the above mentioned problems, there is a known method that involves the user of the electronic device programming a numeric password to be displayed upon the occurrence of a predefined event, following which in most cases the user's intent will be to unlock or access the electronic device. In this case, whenever the user of the electronic device attempts to unlock or access the electronic device, the electronic device displays the programmed password to the user. As a result, the user does not have to remember the password and can use the displayed password to unlock or access the electronic device.

For security purposes, the numeric password described herein can be changed by the user on a frequent basis. However, prior to the programming of a new password, there is always some amount of risk associated with an unauthorized user's access to the existing password information, which would in turn lead to unauthorized access to the electronic device. For example, there can be a scenario whereby the electronic device is stolen by an unauthorized user who will then be able to view the existing password. Furthermore, in this known method, the numeric password is visually displayed to the user on a screen of the electronic device. Any unauthorized person who is looking at the display of the electronic device while the password is being displayed can gain knowledge of the password, once again leading to a high risk associated with unauthorized access to the electronic device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic illustration of pairing of an electronic device and a remote device through a wired or wireless connection via a network.

FIG. 2 is a block diagram showing example internal components of the electronic device in accordance with some embodiments of the present invention.

FIG. 3 is a flowchart showing example steps of operation of the electronic device that is in communication with the remote device, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before describing in detail the particular method and system for unlocking a mobile device via a securely paired audio device, in accordance with an embodiment of the present disclosure, it should be observed that the present disclosure resides primarily in combinations of method steps and apparatus components related to the method and system for unlocking an electronic device via a securely paired remote device. Accordingly, the apparatus components and method steps have been represented where appropriate by conventional symbols in the drawings, showing only those specific details that are pertinent to understanding the present disclosure, so as not to obscure the disclosure with details that will be readily apparent to those of ordinary skill in the art, having the benefit of the description herein.

An electronic device and a method for unlocking the electronic device is disclosed herewith. The method includes pairing the electronic device with a remote device. The electronic device authenticates the remote device, thus establishing a secure and trusted connection. Furthermore, the method includes generating a password at the electronic device, in response to the occurrence of a predefined event. The generated password is then transmitted acoustically to the remote device. A user, after listening to the password, thereafter provides, within a predetermined time, at least one input at the electronic device, in which the inputs corresponds to the password. In other words, the electronic device receives at least one input within the predetermined time. The method further includes unlocking the electronic device in response to determining that the at least one input matches the password.

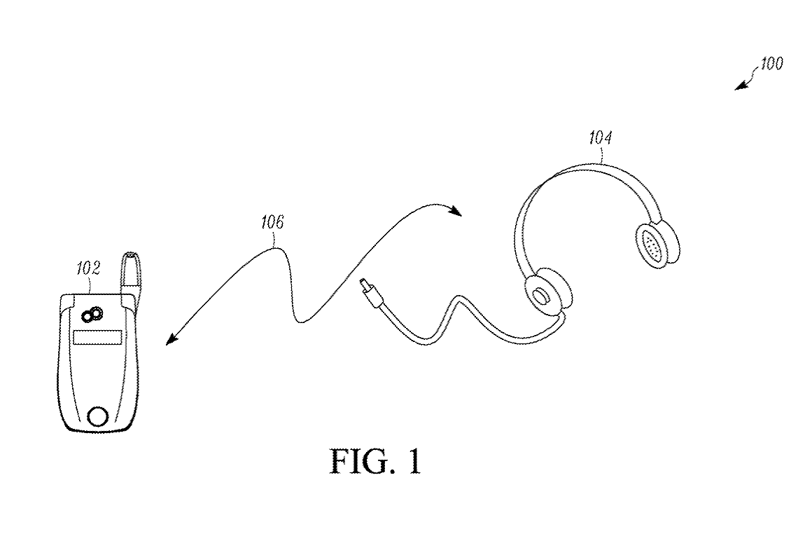

Referring to FIG. 1, an example wireless or wired communication system 100 is shown in a schematic form that is intended to be representative of a variety of different wireless or wired communication systems that are encompassed by the present invention. In the present embodiment, the wireless or wired communication system 100 includes an electronic device 102 that communicates with a remote device 104 via a wireless or wired link 106. In the present embodiment, in FIG. 1 the electronic device 102 is shown to be a mobile device. However, the electronic device 102 is intended to be representative of a variety of other electronic devices. In some embodiments, for example, the electronic device 102 can be any of a call receiver, cellular telephone, a personal digital assistant (PDAs), a smart phone, another handheld or portable electronic device, a headset, a MP3 player, a battery-powered device, a wearable device, a radio, a navigation device, a laptop or notebook computer, a netbook, a pager, a PMP (personal media player), a DVR (digital video recorder), a gaming device, a camera, an e-reader, an e-book, a tablet device, a navigation device with a video capable screen, a multimedia docking station, or a similar mobile or computing device.

In the present embodiment, FIG. 1 shows the remote device 104 as a headphone. However, the remote device 104 is intended to be representative of a variety of other remote devices which are capable of receiving and transmitting audio signals. For example, the remote devices could be any one of, but not limited to, wireless or wired earphones, Bluetooth headset, or any other remote device capable of receiving information acoustically transmitted from the remote device.

The wireless or wired communication system 100 in FIG. 1 also shows a wireless or wired link 106. The wireless or wired link 106 is intended to be representative of a variety of other wireless or wired links including landline connections such as fiber optic or copper wiring connections, microwave communications, radio channel communications, and/or wireless path communications, such as Bluetooth, Zigbee, near field communication, infrared, peer-to-peer Wifi, and the like, depending upon the embodiment or device that is involved.

Moreover, it is to be understood that FIG. 1 is provided merely for the purpose of illustrating the principles of the present invention. FIG. 1 is not intended to be a comprehensive schematic diagram of all of the components of such a communication system. Therefore, wireless/wired communication system 100 may comprise various other configurations and still be within the scope of the present disclosure.

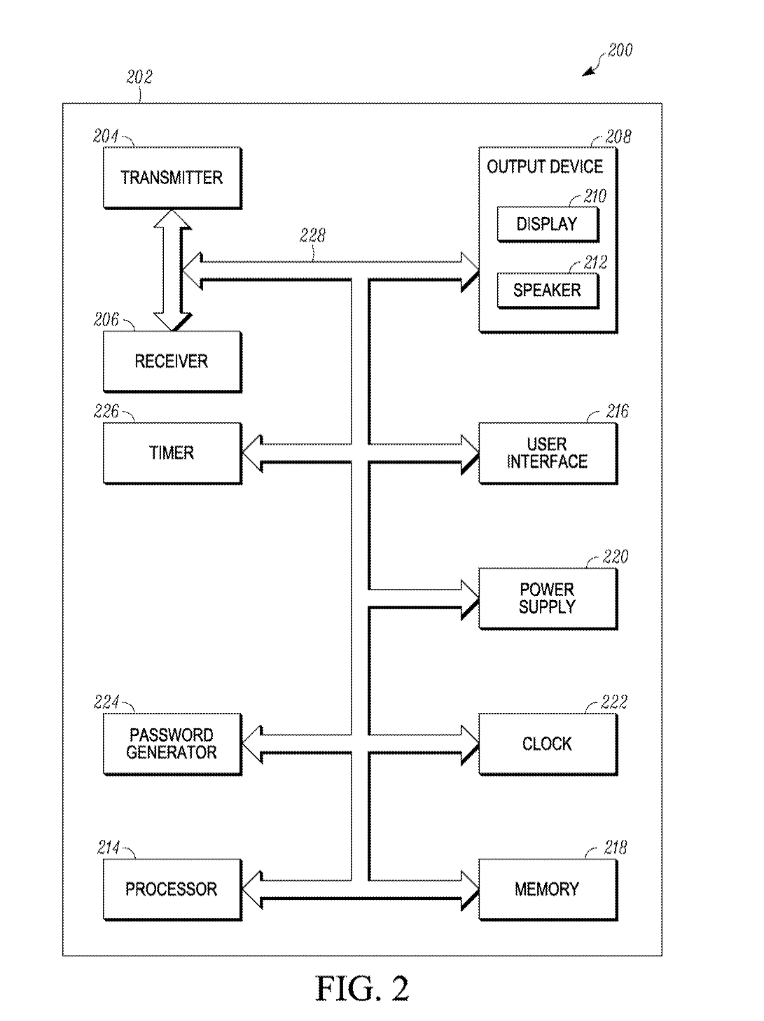

Referring to FIG. 2, there is provided a block diagram 200 illustrating example internal hardware components of the electronic device 102 of FIG. 1. For the purposes of the explanation below, the block diagram 200 will be referred to as describing internal hardware components of a communication device 202. Herein, the communication device 202 refers to electronic device 102.

The block diagram 200 of the communication device 202 includes various components. The example components include a transmitter 204, a receiver 206, an output device 208 including a display 210 and an acoustic output device such as a speaker 212, a processor 214, a user interface 216, a memory 218, a power supply 220, a clock 222, a password generator 224 and a timer 226, each capable of communicating with one or more components of the communication device 202. For example, as shown in FIG. 2, all components are coupled to a bidirectional system bus 228, having one or more of a data communication path, a control communication path or a power supply path.

The transmitter 204 enables the communication device 202 to transmit and the receiver 206 enables the communication device 202 to receive RF signals through an antenna (not shown). In accordance with the embodiment, the receiver 206 converts the RF signals received from the antenna to digital data for use by the processor 214. Each transmitter 204 and/or the receiver 206 of the communication device utilizes wireless technology for communication, such as, but are not limited to, peer-to-peer or ad hoc communications such as Bluetooth, Zigbee, near field communication, infrared, peer-to-peer Wifi, wireless HDMI, wireless USB, HomeRF, and the like. Each wireless transceiver 201 may also utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants.

The output device 208 may generate visual indications of data generated during operation of the processor 214. The visual indications may include prompts for human operator input, calculated values, detected data, etc. Additionally, the output device 208 may include a video output component such as a display device 210 which may include one or more of the following components: a cathode ray tube, a liquid crystal display, a plasma display, an incandescent light, a fluorescent light, a front or rear projection display, or a light emitting diode indicator. Other examples of output components 208 include an audio output component such as a speaker 212, alarm and/or buzzer, and/or a mechanical output component such as vibrating or motion-based.

In accordance with an embodiment, the user interface 216 may be connected to the processor 214 for entering data and commands in the form of text, touch input, gestures, etc. The user interface 216 is, in one embodiment, a touch screen device but may alternatively be an infrared proximity detector or any input/output device combination capable of sensing gestures and/or touch including a touch-sensitive surface. In addition, the user interface 216 may include one or more additional components, such as a video input component such as an optical sensor (for example, a camera), an audio input component such as a microphone, and a mechanical input component such as button or key selection sensors, a touch pad sensor, another touch-sensitive sensor, a capacitive sensor, a motion sensor, and/or a pointing device such as a joystick and buttons used on laptop or notebook computers, a track ball, a touch pad, a rocker switch, a touch screen, a TTY input device for disabled persons, a Braille key input, or a pad for an electronic stylus, for example. The user interface 216 enables a user of the communication device 202 to provide an input for the communication device 202.

Still referring to FIG. 2, the memory 218 may be used to store data and instructions for the operation of the processor 214. In the various embodiments, the memory 218 may be one or more separate components and/or may be partitioned in various ways for various purposes such as but not limited to, optimizing memory allocations, etc. Thus it is to be understood that the example memory 218 illustrated in FIG. 2 are for illustrative purposes only, for the purpose of explaining and assisting one of ordinary skill in understanding the various embodiments described herein.

Additionally, the power supply 220, such as a battery, may be included in the internal components of the communication device 202 for providing power to the other internal components while enabling the communication device 202 to be portable.

Furthermore, the password generator 224 of FIG. 2 is configured to generate a temporary password. The generated password is subsequently stored in the memory 218. The password can be generated in any preferred language or in a combination of preferred languages. The electronic device 202 further includes a clock 222 and a timer 226. The timer 226 is synchronized with the clock 222 and measures time intervals. In another embodiment, the timer 226 and the clock 226 can be integrated together.

Moreover, the processor 214 operates in conjunction with the data and instructions stored in the memory 218 to control the operation of the communication device 202. The processor 214 may be implemented as a microcontroller, a digital signal processor, hard-wired logic and analog circuitry, or any suitable combination of these.

It is to be understood that FIG. 2 is for illustrative purposes only and is primarily for, although not solely for, explaining the information stored in memory for the various embodiments of an electronic device in accordance with the present disclosure, and is not intended to be a complete schematic diagram of the various components and connections for an electronic device. Therefore, a communication device will comprise various other components not shown in FIG. 2, and/or have various other internal and external configurations, and still be within the scope of the present disclosure. Also, one or more of these components may be combined or integrated in a common component, or components features may be distributed among multiple components. Also, the components of the communication device 202 may be connected differently, without departing from the scope of the invention.

Finally, as mentioned above, FIG. 2 can also be considered to be equally or substantially equally representative of the internal components of the remote device 104.

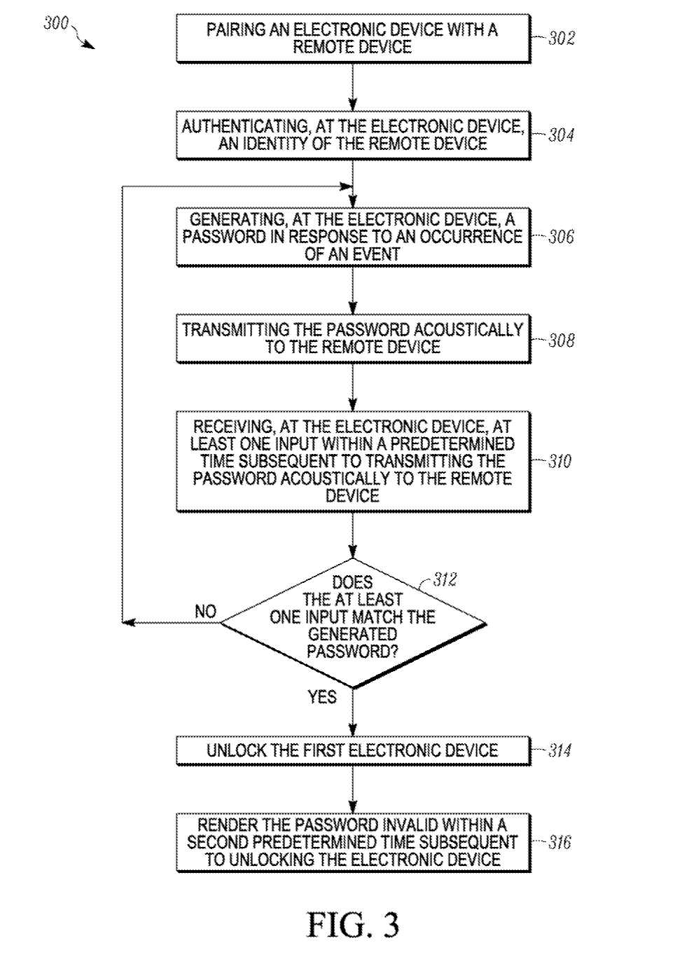

Referring to FIG. 3, a method 300 is provided showing the example steps of unlocking the electronic device via a securely paired remote device. In accordance with the present embodiment, in step 302 the processor 214, the transmitter 204, the receiver 206, or some other component of the communication device 202 pairs the electronic device 102 of FIG. 1 with the remote device 104 of FIG. 1. Herein, the “pairing” means establishing a “secure and unique” connection between the electronic device 102 and the remote device 104. For example, the communication device 202 may utilize Bluetooth pairing to pair a headset with a mobile device, in which the mobile device is configured to “Discoverable” mode and the headset is set up to pair by one or more keys at an input component of the mobile device. The headset finds the phone and establishes a connection using an assigned passkey. Moreover, in step 304 the remote device 104 is authenticated at the electronic device 102 by using a passkey (distinguished from the password discussed below). Herein, in step 304 the processor 214 authenticates the identity of the remote device 104 of FIG. 1. The authentication of the remote device thereby leads to a secure, trusted, and unique connection between the electronic device 102 and the remote device 104.

The “secure and unique” connection between the electronic device 102 and the remote device 104 means that the remote device 104 is authorized to be paired with the electronic device 102. Herein, although the step of authentication of the remote device 104 is shown after the pairing of the electronic device 102 with the remote device 104, it is to be understood that the electronic device 102 may authenticate the remote device 104 before pairing with the remote device 104. Thus, the steps of pairing and authentication, as shown in steps 302 and 304, yield a “secure and unique” connection between the remote device 104 and the electronic device 102.

The method 300 further shows the step of generating, in step 306, by the password generator 224, a temporary password (distinguished from the example pairing passcode described above) in response to occurrence of an event. For example, the password generator 224 may generate the password based on the identity of the remote device, previously authenticated by the communication device 202. The temporary password generated in step 306 is generated at the electronic device 102. In other words, whenever there is an occurrence of a predefined event at the electronic device 102, the password generator 224 may generate a temporary password. The generated temporary password is subsequently stored in the memory 218 of FIG. 2.

Furthermore, herein, the occurrence of an event may include at least one of an incoming call, an incoming message, an incoming email, and/or actuating or pressing of any key at the electronic device. In one embodiment, whenever the electronic device 102 receives an email or a message or an incoming call, it would generate a temporary password. The generated password may comprise at least one or a combination thereof of a set of instructions, alphabetical characters, numerical figures, and/or special characters.

Although the step of generating the temporary password in step 306 is shown after the authentication and pairing steps, it is to be understood that the generation of the temporary password may take place even before the steps of authentication and pairing. For example, in one embodiment, the electronic device 102, which is not paired with any remote device, receives an incoming call. The password generator 224 in the electronic device 102 will generate a temporary password as soon as it receives the incoming call. Thereafter, the user of the electronic device 102 would pair the electronic device 102 with the remote device 104. Moreover, the electronic device 102 would also authenticate the remote device 104, thus establishing a secure and trusted connection. Herein, both the steps of pairing 302 and authentication 304 are followed by the step of generation 306 of the temporary password.

Once the temporary password has been generated at the electronic device 102 and the electronic device 102 is securely and uniquely paired with the remote device 104, in step 308 the temporary password is transmitted acoustically to the paired remote device 104 as shown in the method 300. Herein, the temporary password is transmitted by the transmitter 204 of the FIG. 2. The acoustic transmission of the temporary password in step 308 means that the electronic device 102 transmits audio signals to the remote device 104, in which the audio signals correspond to the generated temporary password. In one embodiment, the audio signals may include a set of instructions or guidelines to be implemented by the user. For example in one embodiment, the set of instructions may describe a sequence of files to be accessed by the user. In another embodiment, the audio signals may correspond to a song. In yet another embodiment, the audio signals may correspond to a numeric number.

In one of the example embodiments, the generated password may be in a user preferred language. For example, the password may be in Chinese language. In another example, the transmitted password may be in a native language of the user of the electronic device, which may be a different language as compared to the native language of the people who are located in the vicinity of the user of the electronic device or who are in the same region as the user of the electronic device. As a result, the security provisions for unlocking or accessing the electronic device are enhanced even further.

The acoustic transmission of the temporary password may be through a wired or wireless link. In one example, the temporary password is transmitted through a wired link to an earphone. Herein, the earphone is one of the example remote devices. In another example, the temporary password may be transmitted through a wireless link to a Bluetooth headset. Herein, the Bluetooth headset is one of the example remote devices.

The user of the electronic device 102 receives the password acoustically via the remote device 104. The user, in step 310, after learning about the password, provides, via the user interface 216 of FIG. 2, at least one input at the electronic device 102. For example, the user may input the password on the electronic device by pressing the keys of the user interface 216 of the electronic device 102. In other words, at least one input corresponding to the temporary password is received at the electronic device 102.

In one embodiment, the received input may be a particular sequence of numeric characters. In another embodiment, the received input may correspond to accessing of various applications and files in a particular sequence. In still another embodiment, when the audio signals received at the remote device correspond to a song, the received input may correspond to inputting of an information related to the song.

Furthermore, the input, at the electronic device has to be received within a predetermined time. The predetermined time may be set by the user of the electronic device 102. The electronic device 102 includes the timer 228 and the clock 224 as shown in FIG. 2. The timer 226 of FIG. 2 monitors the set predetermined time and provides a signal on the expiration if the set predetermined time. The generated temporary password is rendered invalid if no input is received within the set predetermined time.

If at least one input is received within the predetermined time as set by the user, in step 312 the processor 214 of the electronic device 102 proceeds to determine whether the received at least one input matches the generated password that is stored in the memory 218. If there is a match between the received input and the stored password, in step 314 the processor 214 unlocks the electronic device 102. Thus, with the unlocking of the electronic device the user is able to access the files and applications stored within the electronic device 102.

On the other hand, if the received input and the stored password do not match, the method 300 moves back to the step of generating in step 306 a temporary password in response to occurrence of an event. In other words, the method 300 waits for an event to occur to generate a new temporary password.

In one embodiment, the stored password may be rendered invalid as soon as the electronic device is unlocked. In another embodiment, the stored password may be rendered invalid subsequent to the unlocking of the device, within a second predetermined time. The second predetermined time may be set by the user.

Therefore, in accordance with the embodiment of the present invention, a temporary password is generated, at the electronic device 102, in response to an occurrence of an event. The temporary password is stored in the memory of the electronic device 102. The temporary password is also transmitted acoustically to a paired remote device 104, in which the connection between the remote device and the electronic device is secure and unique. Thereafter, an authorized user of the electronic device 102 hears, via the remote device, the temporary password and provides at least one input at the electronic device 102 based on the temporary password. If the at least one input matches with the stored temporary password, the electronic device 102 is unlocked and the temporary password is rendered invalid within the second predetermined time following the unlocking of the electronic device 102.

With embodiments of the present invention, since the temporary password changes frequently, the user does not have to remember them. Furthermore, the remote device 104 (as shown in FIG. 1) has to be proximate to the electronic device 102 in order for the user to hear the generated password. Therefore, even if the electronic device is lost or stolen, the generated password cannot be easily learnt by an unauthorized user at least because he/she would not have the authorized remote device to receive the password. Moreover, since in the present invention the password is heard by the user, it can be transmitted in a preferred language, such as the native language of the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A method for unlocking an electronic device comprising:
pairing the electronic device with a remote device;
authenticating, at the electronic device, an identity of the remote device;
generating, at the electronic device, a password in response to an occurrence of an event at the electronic device;
transmitting the password acoustically to the remote device;
receiving, at the electronic device, at least one input within a predetermined time subsequent to transmitting the password acoustically to the remote device; and
unlocking the electronic device in response to determining that the at least one input matches the password.

2. The method of claim 1, wherein generating the password in response to an occurrence of an event at the electronic device includes generating the password in response to the occurrence of at least one of an incoming call, an incoming message, an incoming email, or actuating a key at the electronic device.

3. The method of claim 1, wherein generating the password in response to an occurrence of an event at the electronic device includes generating the password based on the identity of the remote device.

4. The method of claim 1, wherein transmitting the password to the remote device includes transmitting the password to the remote device subsequent to authenticating the identity of the remote device.

5. The method of claim 1, further comprising:
rendering the password invalid within a second predetermined time subsequent to unlocking the electronic device.

6. The method of claim 1, wherein the password comprises at least one of a set of instructions, alphabetical characters, numerical figures, or special characters.

7. The method of claim 1, wherein the password is in a preferred language.

8. An electronic device comprising:
a housing;
a display supported by the housing;
a power source;
a password generator configured to generate a password based upon an occurrence of an event at the electronic device;
a transmitter configured to transmit the password acoustically to a remote device;
a user interface configured to receive at least one input within a predetermined time subsequent to the transmitter transmitting the password acoustically to the remote device; and
a processor configured to authenticate an identity of the remote device and unlock the electronic device in response to determining that the at least one input matches the password.

9. The electronic device of claim 8, wherein the password generator configured to generate the password based upon the occurrence of the event includes the password generator configured to generate the password based upon the occurrence of at least one of an incoming call, an incoming message, an incoming email, or actuating a key at the electronic device.

10. The electronic device of claim 8, wherein the password generator generates the password based on the identity of the remote device.

11. The electronic device of claim 8, wherein the transmitter transmits the password to the remote device subsequent to the processor authenticating the identity of the remote device.

12. The electronic device of claim 8, wherein the processor is further configured to render the password invalid within a second predetermined time subsequent to unlocking the electronic device.

13. The electronic device of claim 8, wherein the password comprises at least one of a set of instructions, alphabetical characters, numerical figures, or special characters.

14. The electronic device of claim 8, wherein the password is in a preferred language.

15. The electronic device of claim 8, wherein the remote device is an audio device.

16. The electronic device of claim 8, further comprising:
a memory configured to store the password.
